(19) United States
(12) Patent Application Publication
(10) Pub. No.: US 2011/0257989 A1
(43) Pub. Date: Oct. 20, 2011

(54) PRESCRIPTION MANAGEMENT SYSTEMS AND METHODS FOR MOBILE COMMUNICATION DEVICES

(75) Inventor: Rajit Potaraju Kumar, Irving, TX (US)

(73) Assignee: SpinSci Technologies LLC, Irving, TX (US)

(21) Appl. No.: 12/762,276

(22) Filed: Apr. 16, 2010

(51) Int. Cl. G06Q 50/00; G06F 3/048; G06F 17/30; G06Q 10/00

(52) U.S. Cl. 705/2; 715/810; 707/802; 707/769; 707/E17.044; 707/E17.014

(57) ABSTRACT

The illustrative embodiments described herein provide systems and methods for managing prescription-related health care data for a patient using a mobile communication device. In one embodiment, a method includes identifying prescription status data for a prescription associated with a patient. The patient is a user of a mobile communication device. The method also includes determining whether the prescription is ready for retrieval from a pharmacy using the prescription status data, and initiating a prescription availability notification on the mobile communication device in response to determining that the prescription is ready for retrieval from the pharmacy. The prescription availability notification notifies the patient that the prescription is ready for retrieval from the pharmacy. The method also includes presenting a set of selectable modules on a graphical user interface of the mobile communication device. At least a portion of the set of selectable modules is related to the prescription.

### TECHNICAL FIELD

The illustrative embodiments relate generally to health care-related mobile communication device applications, and more particularly, to prescription management systems and methods for mobile communication devices.

### BACKGROUND

Today, prescription medication is prescribed to patients for a wide variety of ailments. After receiving a prescription, patients may fill their prescriptions at a pharmacy or other health care facility or service. However, patients often have no convenient way of knowing when their prescriptions have been filled by their pharmacy and are ready to be picked up, or otherwise retrieved. In addition, patients may have no convenient way to access details and other data related to their prescription. Overall, current systems fail to effectively and conveniently utilize mobile communication devices to help patients manage their prescription-related health care issues.

### SUMMARY

According to an illustrative embodiment, a method for managing prescription-related health care data for a patient using a mobile communication device includes identifying prescription status data for a prescription associated with a patient. The patient is a user of a mobile communication device. The method also includes determining whether the prescription is ready for retrieval from a pharmacy using the prescription status data, and initiating a prescription availability notification on the mobile communication device in response to determining that the prescription is ready for retrieval from the pharmacy. The prescription availability notification notifies the patient that the prescription is ready for retrieval from the pharmacy. The method also includes presenting a set of selectable modules on a graphical user interface of the mobile communication device. At least a portion of the set of selectable modules is related to the prescription.

According to another illustrative embodiment, a prescription management system for managing prescription-related health care data for a patient using a mobile communication device includes a health care database. The health care database includes prescription data associated with a set of prescriptions for a set of patients. The prescription data includes prescription status data associated with the set of prescriptions. The prescription management system also includes a prescription management application executable on a mobile communication device associated with a patient. The prescription management application includes a prescription status module to retrieve the prescription status data for a prescription associated with the patient from the health care database and to present the prescription status data on a graphical user interface of the mobile communication device.

According to another illustrative embodiment, a computer program product includes a computer-usable medium having computer-usable program code for managing prescription-related health care data for a patient using a mobile communication device. The computer program product includes computer-usable program code for initiating a prescription availability notification on the mobile communication device in response to determining that a prescription associated with the patient is ready for retrieval from a pharmacy. The computer program product also includes computer-usable program code for presenting, for patient selection, a set of selectable modules on the graphical user interface of the mobile communication device. The set of selectable modules includes at least one of a prescription status module, a pharmacy module, a prescription data module, or a physician module.

### BRIEF DESCRIPTION OF THE DRAWINGS

FIG. 1 is a schematic, pictorial representation of a prescription management system according to an illustrative embodiment;

FIG. 2 is a schematic diagram of a prescription management system according to an illustrative embodiment;

FIG. 3 is a schematic, pictorial representation of a prescription availability notification displayed on a mobile communication device according to an illustrative embodiment;

FIG. 4 is a schematic, pictorial representation of a prescription entry prompt displayed on a mobile communication device according to an illustrative embodiment;

FIG. 5 is a schematic, pictorial representation of a mobile communication device showing the status of a prescription according to an illustrative embodiment;

FIG. 6 is a schematic, pictorial representation of a mobile communication device showing the location of a pharmacy according to an illustrative embodiment;

FIG. 7 is a schematic, pictorial representation of a mobile communication device showing a list of pharmacies according to an illustrative embodiment;

FIG. 8 is a schematic, pictorial representation of a mobile communication device showing pharmacy data about a pharmacy according to an illustrative embodiment;

FIG. 9 is a schematic, pictorial representation of a mobile communication device showing the route between a user and a pharmacy according to an illustrative embodiment;

FIG. 10 is a schematic, pictorial representation of a mobile communication device showing prescription data for a prescription according to an illustrative embodiment;

FIG. 11 is a schematic, pictorial representation of a mobile communication device showing physician data for a physician according to an illustrative embodiment;

FIG. 12 is a schematic, pictorial representation of a mobile communication device showing patient data for a patient according to an illustrative embodiment;

FIG. 13 is a flowchart of a process for managing prescription-related health care data for a patient using a mobile communication device according to an illustrative embodiment;

FIG. 14 is a flowchart of a process for managing prescription-related health care data for a patient using a mobile communication device according to another illustrative embodiment;

FIG. 15 is a flowchart of a process for managing prescription-related health care data for a patient using a mobile communication device according to an illustrative embodiment;

FIG. 16 is a flowchart of a process for managing prescription-related health care data for a patient using a mobile communication device according to an illustrative embodiment; and

FIG. 17 is a schematic, block diagram of a data processing system, such as a mobile communication device, in which the illustrative embodiments may be implemented.

### DETAILED DESCRIPTION

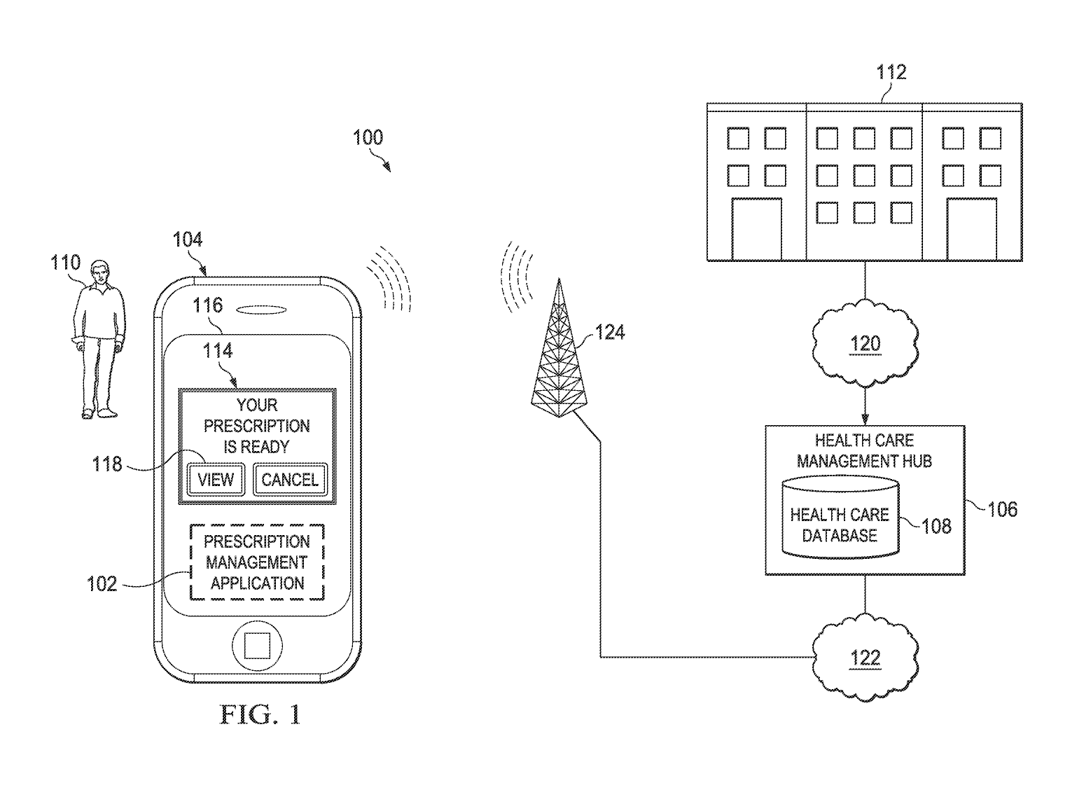

Referring to FIG. 1, an illustrative embodiment of a prescription management system 100 includes a prescription management application 102, which resides, or is executable, on a mobile communication device 104, and a health care management hub 106 that includes a health care database 108. The mobile communication device 104 is operable or usable by a patient 110. The patient 110 may use the prescription management application 102 to manage his or her prescriptions or other prescription-related health care data. Unless otherwise indicated, as used herein, “or” does not require mutual exclusivity.

In an illustrative embodiment, the prescription management application 102 executing on the patient's mobile communication device 104 communicates with the health care database 108 so that data about the patient's prescriptions, pharmacy 112, physician, or other prescription or health care-related issues may be presented to the patient 110 on the patient's mobile communication device 104. For example, after filling his or her prescription at the pharmacy 112, the patient 110 may use the prescription management application 102 to obtain information about the prescription being filled at the pharmacy 112, such as when the prescription is ready to be picked up from the pharmacy 112. The health care data that is accessed by the prescription management application 102 may be stored in the health care database 108. The health care database 108 may receive the data stored therein from any source having health care data related to the patient 110. In one non-limiting example, the health care database 108 may receive at least a portion of the health care data stored therein, such as when the prescription is ready to be picked up, directly or indirectly from the pharmacy 112. For example, the pharmacy 112 may directly or indirectly update the status of a prescription refill in the health care database 108.

In one embodiment, the prescription management application 102 initiates a prescription availability notification 114 on a graphical user interface 116 of the mobile communication 104 when the prescription management application 102 determines that the patient's prescription is ready to be picked up, or retrieved, from the pharmacy 112. The prescription may be considered to be ready for retrieval when, for example, the prescription has been filled by the pharmacy 112, or the prescription is ready to be tendered to the patient 110 using any method, including mail, courier, third-party pick-up, pick-up by the patient, etc. The prescription management application 102 or the health care management hub 106 may use prescription status data, which resides in the health care database 108, to determine whether the prescription is ready for retrieval from the pharmacy 112. The prescription status data, described in further detail below, may be received directly or indirectly from the pharmacy 112. The prescription availability notification 114 notifies the patient 110 that his or her prescription is ready for retrieval from the pharmacy 112, and may include data about the prescription, such as any combination of prescription-related data stored in the health care database 108.

The prescription availability notification 114 may be initiated on the mobile communication device 104 using a “push” notification, and in one embodiment the push notification may be initiated by the health care management hub 106 or other server or service associated with the mobile communication device 104 or the prescription management application 102. The push notification may use any push or server push technology. The prescription availability notification 114 may also be initiated by the prescription management application 102.

If the patient 110 fills his or her prescription for a particular medication at the pharmacy 112, the pharmacy 112 may transmit data to be health care database 108 that indicates if or when the prescription has been filled and is ready for retrieval by the patient 110. If the prescription status data sent by the pharmacy 112 indicates that the prescription is ready for retrieval, the prescription management application 102 may access this prescription status data and determine that the prescription is ready for retrieval from the pharmacy 112. In response, the prescription management application 102 initiates the prescription availability notification 114 on the mobile communication device 104, thereby notifying the patient 110 that he or she may pick up his or her prescription at the pharmacy 112.

In the illustrative embodiments, the patient 110 may also use the prescription management application 102 to access a wide variety of data that relates to the prescription. In one embodiment, the patient 110 may press, or otherwise select, a selectable prescription details option 118 on the prescription availability notification 114. Pressing the selectable prescription details option 118 causes the prescription management application 102 to present a set of selectable modules on the graphical user interface 116 of the mobile communication device 104. As used herein, the term “set” encompasses a quantity of one or more. At least a portion of these selectable modules may relate to the prescription. In another embodiment, the patient 110 may also access the set of selectable modules by inputting a prescription identifier, such as a prescription number, corresponding to the prescription so that the prescription management application 102 may access and present data related to the prescription. Additional details regarding the selectable modules are described below.

If the prescription management application 102 is not already on the mobile communication device 104, the patient 110 may download the prescription management application 102, such as by purchasing the prescription management application 102 from an application vendor. The prescription management application 102 may also be downloaded from the health care management hub 106. In another embodiment, the health care management hub 106 may initiate the prescription availability notification 114 on the mobile communication device 104 prior to the installation of the prescription management application 102 onto the mobile communication device 104; in this embodiment, the prescription management application 102 may be downloaded onto the mobile communication device 104 when the patient 110 selects the selectable prescription details option 118 on the prescription availability notification 114. In another embodiment, the prescription availability notification 114 may be in the form of an SMS, or text message, which is sent to the mobile communication device 104. The text message may inform or remind the patient 110 to download the prescription management application 102. In another embodiment, prescription availability notification 114 may be in the form of a phone call to the patient 110. The phone call may inform or remind the patient 110 to download the prescription management application 102.

The mobile communication device 104, on which the prescription management application 102 is executable, may be a cellular phone (e.g., a smart phone), a walkie talkie, a computer (e.g., a laptop, netbook, tablet computer, or minicomputer), a personal digital assistant, a digital music player, a digital reader, a portable gaming device, a web browsing device, a media player, or any other electronic device that is mobile and capable of executing an application. In the embodiment in which the mobile communication device 104 is a cellular phone, any make or model may be used to execute the prescription management application 102, such as an iPhone® or other cellular phone made by Apple®, Inc., a Nexus One® or other cellular phone made by Google®, a Droid or other cellular phone made by Motorola®, a BlackBerry® or other cellular phone made by Research in. Motion® Limited Corporation, a smartphone made by Samsung®, or any other type, make, or model of cellular phone or smartphone capable of executing an application.

The health care management hub 106 may reside in one or more servers at a data center or other location. For example, the health care management hub 106, which includes the health care database 108, may be implemented on an SQL server. The health care database 108 may be implemented using any storage device. In one non-limiting example, the prescription management application 102 communicates with the health care database 108 through a web service. For example, the prescription management application 102 may access data in the health care database 108 through a web service. The web service may use any platform, such as C# or .NET.

The techniques, technologies, or media by which the components of the prescription management system 100 intercommunicate are numerous. For example, the prescription management system 100, or any portion thereof, may be part of a personal area network (PAN), a local area network (LAN), a campus area network (CAN), a metropolitan area network (MAP), or any other network type. Data communication medium 120 between the pharmacy 112 and the health care management hub 106 may be any medium through which data can be communicated. For example, the data communication medium 120 may be wired or wireless data connections, and may utilize a virtual private network (VPN), multi-protocol label switching (MPLS), the Internet, or any other data communication media.

The data communication medium 122 between the health care management hub 106 and the base station 124 may be of the same or similar type as any of the non-limiting examples provided for the data communication medium 120. In addition to the server on which the health care management hub, 106 may be implemented, additional intervening servers may facilitate data communication or storage within the prescription management system 100. Wireless communication between the mobile communication device 104 and the base station 124 may utilize any wireless standard for communicating data, such as CDMA (e.g., cdmaOne or CDMA2000), GSM, 3G, 4G, Edge, an over-the-air network, Bluetooth, etc. Any of the transactions occurring in the prescription management system 100 may be performed using secure SSL transactions.

In one example, the prescription management system 100 may utilize the Internet, with any combination of the data communication media 120, 122 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. FIG. 1 is intended as an example, and not as an architectural limitation for the different illustrative embodiments.

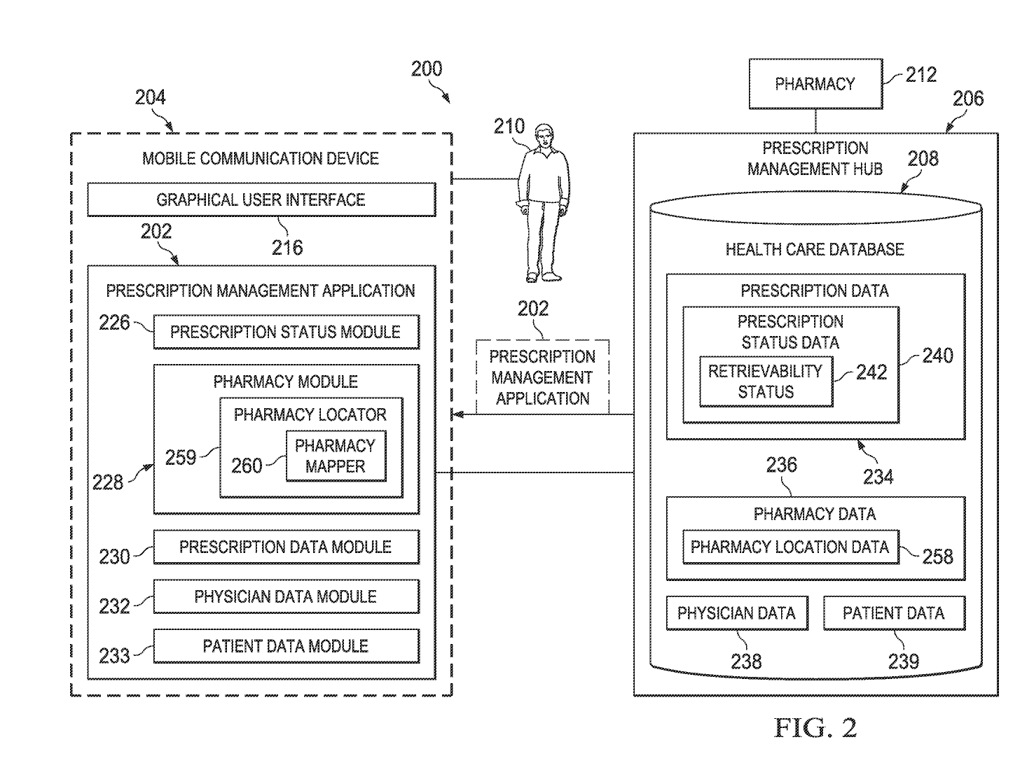

Referring to FIGS. 2 through 11, an illustrative embodiment of the prescription management system 200 includes the prescription management application 202, which is executable on the mobile communication device 204, in communication with the prescription management hub 206, which includes the health care database 208. Components of FIGS. 2-11 that are analogous to components in FIG. 1 have been shown by indexing the reference numerals by 100. The prescription management application 202 includes a set of selectable modules that assist the patient 210 in managing his or her prescriptions. In one illustrative embodiment, the set of selectable modules includes a prescription status module 226, a pharmacy module 228, a prescription data module 230, a physician data module 232, and a patient data module 233.

The prescription management application 202, including the selectable modules therein, may access data from or send data to the health care database 208. In one illustrative embodiment, the health care database 208 includes prescription data 234, pharmacy data 236, physician data 238, and patient data 239. The health care database 208 may include prescription data 234, pharmacy data 236, physician data 238, or patient data 239 for any number of prescriptions, patients, or health care workers, and the data contained in the health care database 208 may be accessed by any number of prescription management applications 202 and their respective patients 210.

The prescription data 234 may include any data relating to a prescription associated with the patient 210, including, but not limited to, the name of the patient 210, the name of the drug associated with the prescription, the number of refills remaining for the prescription, the next refill date for the prescription, the number of refills authorized for the prescription, the expiration date for the prescription, the National Drug Code (NDC) number, the Drug Enforcement Agency (DEA) schedule or class of the drug, the quantity of the prescription in stock at a particular pharmacy, a flag or boolean indicating whether the prescription may be transferred, directions for using the prescription, including dosage information or directions from the signature portion of the prescription, any identifier(s) for a third party insurance plan, etc. The refill data included in the prescription data 234 may include refill data for the first fill, last fill, or any other fill for a particular prescription, including a sequence number associated with the fill (e.g., 0=first fill), a number representing the sequence of a partial fill (e.g., 0=full fill), the amount of product dispensed in a fill, the number of days a fill was intended to last the patient, the data a prescription was filled, etc. The pharmacy data 236 may include any data relating to a pharmacy such as pharmacy 212, including, but not limited to, the store number of the pharmacy 212, the address of the pharmacy 212, the ZIP code of the pharmacy 212, the operating hours of the pharmacy 212, the phone number of the pharmacy 212, the e-mail address of the pharmacy 212, any contact information of the pharmacy 212, the website of the pharmacy 212, a manager or employee of the pharmacy 212, etc.

The physician data 238 may include any data relating to a physician or other health care worker or prescriber associated with the patient 210 or pharmacy 212, including, but not limited to, the name of the prescribing physician, the address of a physician, a ZIP code of a physician, the phone number of a physician, the e-mail addresses of a physician, the Drug Enforcement Agency (DEA) number of the physician, the preferred contact method of the physician, etc. The patient data 239 may include any data relating to the patient 210 or other patient associated with the pharmacy 212, including, but not limited to, the first and last name of the patient, the contact information for the patient, the date of birth of the patient, a patient identifier, the patient's social security number, a medical record number of the patient, the patient's prescriptions, etc. The contact information for the patient may include the patient's primary and secondary phone number, e-mail address, physical address, etc.

In one embodiment, the prescription status module 226 accesses the prescription status data 240 from the health care database 208, and presents the prescription status data 240 to the patient 210 as a display or notification. The prescription status data 240 may be a part of the prescription data 234 in the health care database 208. The prescription status data 240 includes data that indicates a current status of the prescription associated with the patient 210, including, but not limited to, whether the prescription is ready for retrieval from the pharmacy 212, data regarding the prescription requested by the patient 210, etc.

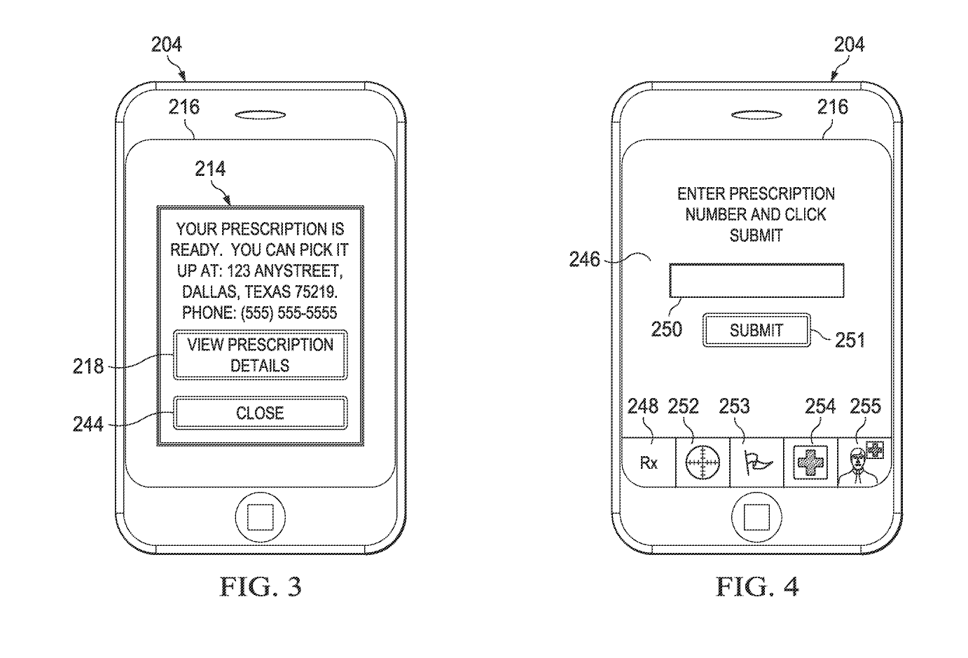

With particular reference to FIGS. 2 and 3, the prescription status module 226 may notify the patient 210 when his or her prescription is ready to be retrieved from the pharmacy 212. In one non-limiting example, the prescription status module 226 may access or retrieve a retrievability status 242 in the health care database 208. The retrievability status 242 may be included as part of the prescription status data 240. The retrievability status 242 indicates whether the prescription associated with the patient 210 is ready to be retrieved from the pharmacy 212. In one embodiment, the retrievability status 242 may have either a retrievable status, which indicates that the prescription is ready to be retrieved from the pharmacy 212, or a non-retrievable status, which indicates that the prescription is not ready to be retrieved from the pharmacy 212. The retrievability status 242, as well as the prescription status data 240, may be determined, changed, or updated based on data received directly or indirectly from the pharmacy 212. For example, after the patient 210 has requested the pharmacy 212 to fill his or her prescription, the pharmacy 212 may send data to the health care database 208 that indicates that the prescription has been filled and is ready to be picked up by the patient 210; in this case, the retrievability status 242 may be changed to a retrievable status.

The prescription status module 226 may identify the prescription status data 240, including ₜhe retrievability status 242, of the prescription associated with the patient 210, and determine whether the prescription is ready to be retrieved from the pharmacy 212. The determination of whether or not the prescription is ready to be retrieved from the pharmacy 212 may be determined based on the prescription status data 240 or the retrievability status 242 of the prescription. In another embodiment, the determination as to whether the prescription is ready to be retrieved from the pharmacy 212 may be performed by the prescription management hub 206.

When the prescription status module 226 determines that the prescription associated with the patient 210 is retrievable from the pharmacy 212, the prescription status module 226 may initiate the prescription availability notification 214 on the graphical user interface 216 of the mobile communication device 204. The prescription availability notification 214, an example of which is shown in FIG. 3, notifies the patient 210 that his or her prescription is ready for pick-up at the pharmacy 212, and may also include any combination of data accessed from the health care database 208. In the non-limiting example of FIG. 3, the prescription availability notification 214 includes the address and phone number of the pharmacy 212.

The prescription availability notification 214 also includes the selectable prescription details option 218, which is selectable by the patient 210. The prescription management application 202 may detect when the patient 210 presses, or otherwise selects, the selectable prescription details option 218. When the prescription management application 202 detects that the patient 210 has selected the selectable prescription details option 218, which may be labeled in any fashion, the prescription management application 202 may present any combination of the selectable modules 226, 228, 230, 232 on the graphical user interface 216. In one embodiment, the prescription management application 202 may execute, or fully present, any one of the selectable modules 226, 228, 230, 232 at a time on the graphical user interface 216 based on a user selection. In one embodiment, when the selectable prescription details option 218 is selected, the data presented by the selectable modules 226, 228, 230, 232 pertains to the prescription for which the prescription availability notification 214 is displayed. The patient 210 may also select a close button 244 on the prescription availability notification 214, in which case the prescription management application 202 does not present the selectable modules 226, 228, 230, 232, or otherwise launch other features of the prescription management application 202.

Selection of the selectable prescription details option 218 by the patient 210 is one way in which the prescription management application 202 may launch, or present, the selectable modules 226, 228, 230, 232 for selection by the patient 210 on the graphical user interface 216. In one embodiment, the selectable modules 226, 228, 230, 232 may also be used to present data about a particular prescription using a prescription entry prompt 246 that is displayed on the graphical user interface 216 by the prescription management application 202. A non-limiting example of the prescription entry prompt 246 is shown in FIG. 4.

The prescription entry prompt 246 may be displayed on the graphical user interface 216 of the mobile communication device 204 in response to the patient's selection of a prescription entry prompt activation button 248. The prescription entry prompt 246 includes a prescription identifier field 250. The prescription management application 202 may receive, from the patient 210, a prescription identifier in the prescription identifier field 250. The prescription identifier may be any set of characters that facilitates identification of a prescription, such as a prescription number, a drug name, a transaction number, a receipt number, payment method data, a pharmacy name or location, etc. The prescription management system 200 may then identify the prescription using the prescription identifier inputted by the patient 210. In one example, the prescription management application 202 uses the prescription data 234 in the health care database 208 to identify the prescription associated, with the prescription identifier. Also, the patient 210 may trigger the identification of the prescription by the prescription management system 200 by selecting a submit button 251 on the prescription entry prompt 246. After the prescription has been identified by the prescription management application 202, any of the selectable modules 226, 228, 230, 232 may be accessed by the patient 210 so that the accessed selectable module 226, 228, 230, 232 may present data about the prescription that has been identified.

In one embodiment, certain features of the prescription status module 226, the pharmacy module 228, the prescription data module 230, or the physician data module 232 may be accessed when the patient 210 selects a prescription status module activation button 252, a pharmacy module activation button 253, a prescription data module activation button 254, or a physician data module activation button 255, respectively. The prescription status module activation button 252, the pharmacy module activation button 253, the prescription data module activation button 254, the physician data module activation button 255, as well as the prescription entry prompt activation button 248, may be displayed by the prescription management application 202 on the graphical user interface 216 to facilitate selection by the patient 210. When the patient selects the prescription status module activation button 252, the pharmacy module activation button 253, the prescription data module activation button 254, the physician data module activation button 255, or the prescription entry prompt activation button 248, the corresponding module or prompt appears on the graphical user interface 216, and the corresponding module or prompt may display data about a prescription that is associated with the patient 210, including a prescription that has been identified using the prescription entry prompt 246.

For example, the patient 210 may select the prescription status module activation button 252 to cause the prescription management application 202 to display the prescription status, as shown in FIG. 5. The prescription status module 226 may access and identify the prescription status data 240 for the prescription in the health care database 208, and display the prescription status data 240 on the graphical user interface 216 of the mobile communication device 204. In the example of FIG. 5, the displayed prescription status data indicates that the prescription is ready for retrieval from the pharmacy 212, as well as the location and phone number of the pharmacy 212. In other embodiments, any combination of data in the health care database 208 may be displayed by the prescription status module 226 upon selection of the prescription status module activation button 252, such as a prescribing physician, an e-mail address of the pharmacy 212, the operating hours of the pharmacy 212, or any other data in the health care database 208.

The prescription management application 202 includes the pharmacy module 228. The pharmacy module 228 includes a pharmacy locator 259, which is operable to locate one or more pharmacies, and the pharmacy locator 259 may include a pharmacy mapper 260, which accesses, generates, or displays maps that include a pharmacy, such as the pharmacy 212. The maps that are displayed by the pharmacy mapper 260 may be based on pharmacy location data 258 in the health care database 208. The pharmacy locator 259 can be used to present location data for the pharmacy 212 on the graphical user interface 216. In another embodiment, the pharmacy locator 259 or the pharmacy mapper 260 may be included in another part of the prescription management system 100, such as the prescription management hub 206, or may work in conjunction with outside applications or services, such as Google® maps or MapQuest®.

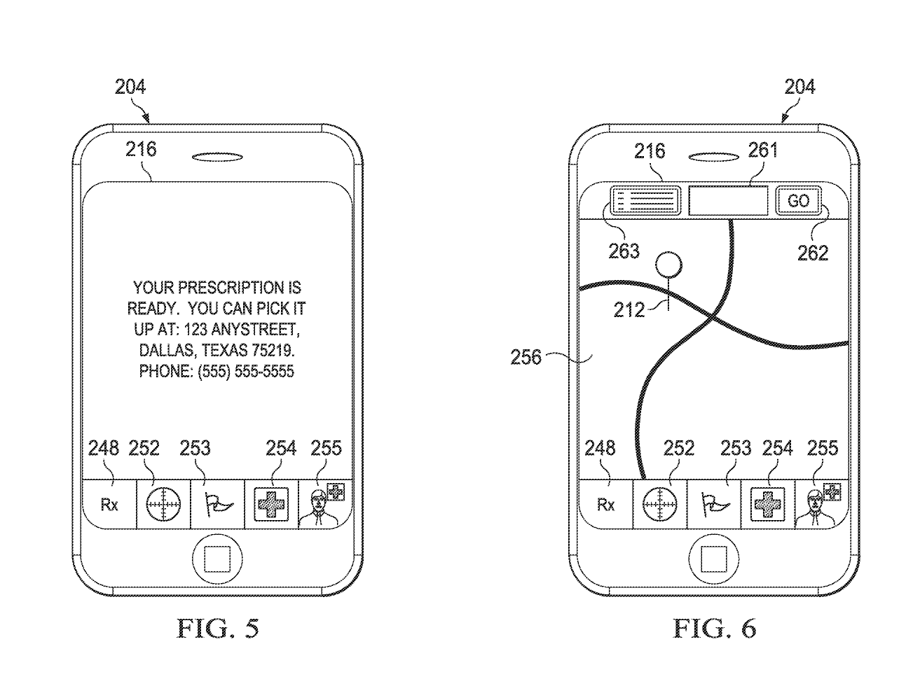

The pharmacy module 228 may be initiated when the patient 210 selects the pharmacy module activation button 253. The pharmacy module 228 is described with reference to FIGS. 2 and 6-9. When the patient 210 selects the pharmacy module activation button 253, a location of the pharmacy 212 may be displayed on the graphical user interface 216 by the pharmacy mapper 260. With particular reference to FIG. 6, the location of the pharmacy 212 is shown using a map 256 that indicates the location of the pharmacy 212. The location of the pharmacy 212 may be part of the pharmacy location data 258, which is included in the pharmacy data 236. The pharmacy module 228 may access the pharmacy location data 258 in the health care database 208, and display the location of the pharmacy 212 on the graphical user interface 216. In other embodiments, the pharmacy mapper 260 may work in conjunction with other mapping applications, such as Google® maps, MapQuest®, or any other mapping application, and display a map that is at least partially generated by the outside mapping application.

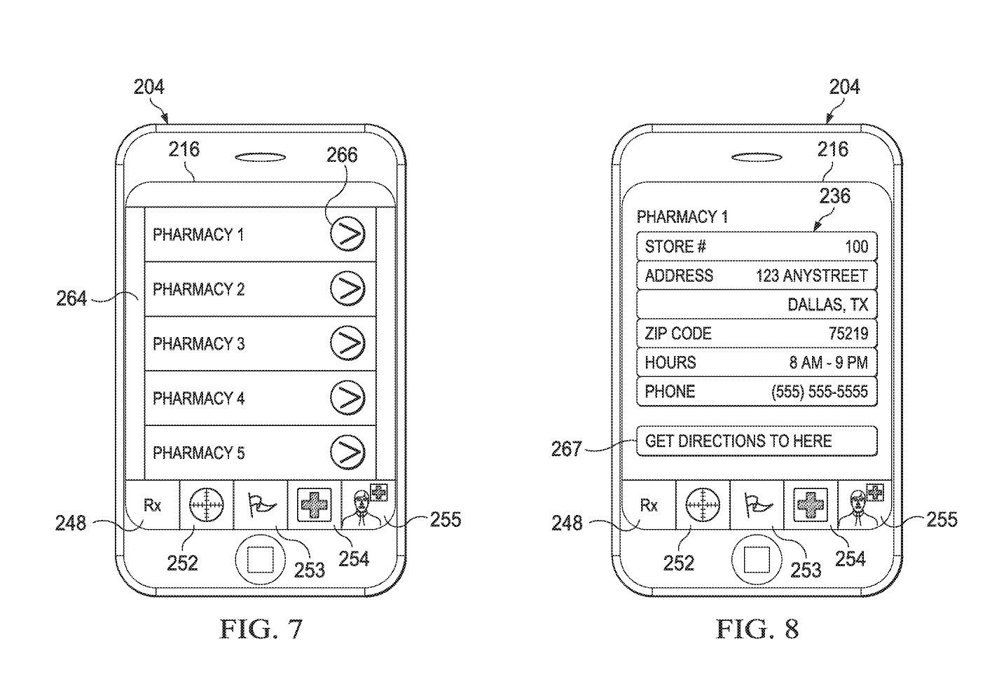

The display in FIG. 6 generated by the pharmacy module 228 also includes a pharmacy search field 261. The pharmacy search field 261 allows the patient 210 to search for a pharmacy using search criteria such as a zip code, a city, a state, a street, a pharmacy name, or any other search criteria. Once the search criteria is inputted in the pharmacy search field 261, the patient 210 may select a go, or search, button 262 to cause the pharmacy locator 259 to search for a pharmacy using the patient's search criteria. Wildcard characters, such as an asterisk (*), may also be entered in the pharmacy search field 261. A wildcard character can be used to broaden, or otherwise modify, the search for a pharmacy since the wildcard character can take on any potential character, such as a number or letter. After selecting the go button 262, a list of pharmacies that match the search criteria entered in the pharmacy search field 261 and/or from which the prescription may be retrieved may be displayed on the graphical user interface 216, a display that is similar to that shown in FIG. 7.

Referring back to FIG. 6, the pharmacy module 228 also includes a pharmacy list button 263, which, when selected, causes a list of pharmacies 264 to be displayed on the graphical user interface 216, as shown in FIG. 7. The list of pharmacies 264 may include pharmacies at which the prescription associated with the patient 210 may be retrieved. The pharmacies in the list of pharmacies. 264 may be identified using the pharmacy name, a pharmacy location, or any other identifier.

To view the details for a pharmacy in the list of pharmacies 264, the patient 210 may select a details button 266 that is adjacent each pharmacy in the list of pharmacies 264. Upon selection of the pharmacy details button 266, the pharmacy module 228 may retrieve and display pharmacy data 236 regarding the pharmacy beside which the selected details button 266 is located. The pharmacy module 228 may retrieve this data from the pharmacy data 236 in the health care database 208. FIG. 8 shows the pharmacy data 236 for “PHARMACY 1” in the list of pharmacies 264. The pharmacy data 236 that is displayed on the graphical user interface 216 may include any data related to the pharmacy for which additional detail is requested, such as the store number, the address of the pharmacy, the ZIP code of the pharmacy, the operating hours of the pharmacy, the phone number of the pharmacy, the e-mail address of the pharmacy, the supervisor or manager of the pharmacy, etc.

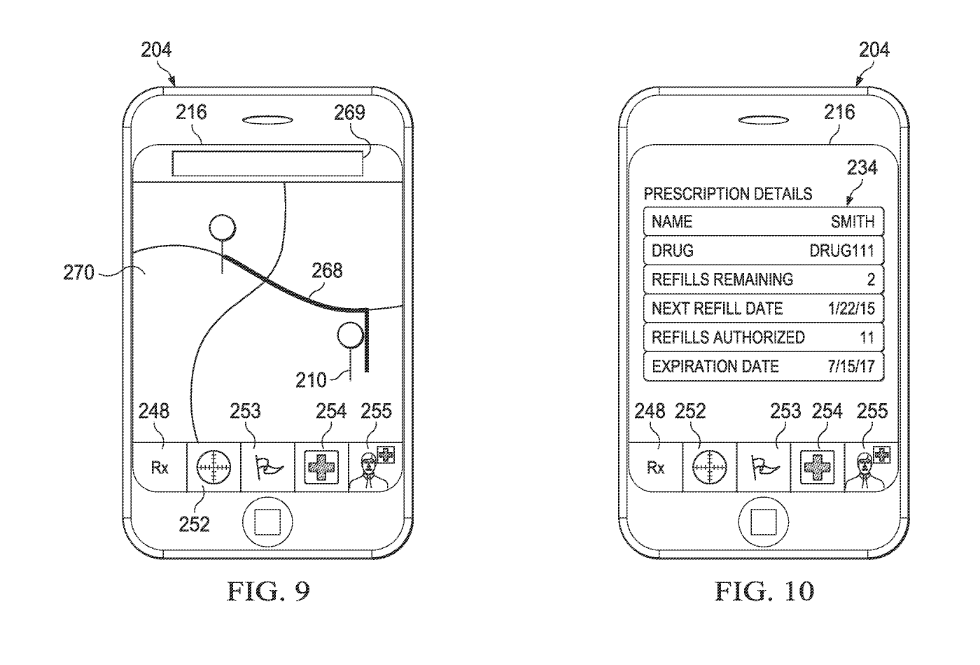

As further shown in FIG. 8, a directions button 267 may also be displayed by the pharmacy module 228. The directions button 267, when selected, may cause the pharmacy mapper 260 to show a route 268 between the patient 210 and the pharmacy for which the pharmacy data 236 is shown. An example display of the route 268 between the patient 210 and the pharmacy is shown in FIG. 9. The pharmacy mapper 260 is also able to show the route 268 between the patient 210 and any other pharmacy, such as the pharmacy 212. The pharmacy module 228 may use the pharmacy location data 258 to identify the location of the pharmacy. To map the location of the patient 210 and to identify the route 268 between the patient 210 and the pharmacy, the prescription management application 202 may identify the location of the patient 210 using any method capable of locating mobile communication devices, such as GPS, triangulation, or other such systems. Once the location of the patient 210 and the pharmacy are known, the route 268 may be mapped as shown in FIG. 9.

Direction details may also be included in a direction details field 269, and the direction details field 269 may include latitudinal or longitudinal markers for the directions between the patient 210 and the pharmacy. For example, the direction details field 269 may include the latitude or longitude of either or both of the patient 210 and the pharmacy to which a route 268 is mapped. The pharmacy mapper 260 may also use an outside mapping application, such as Google® maps or MapQuest®, to retrieve and display the map 270 shown in FIG. 9.

The prescription data module 230 may be initialized when the patient 210 selects the prescription data module activation button 254. The prescription data module 230, upon being selected by the patient 210, retrieves and displays prescription data 234, or at least a portion thereof, on the graphical user interface 216, as shown in FIG. 10. The prescription data 234 that is displayed upon selection of the prescription data module activation button 254 may include the patient's name, the name of the drug associated with the prescription, the number of refills remaining in the prescription, the next refill date of the prescription, the number of refills authorized for the prescription, the expiration date for the prescription, etc. In one embodiment, the prescription data 234 that is displayed may also include dosage information about the patient's prescription, such as the number of times per day the patient 210 should take the prescription. In yet another embodiment, the prescription management application 202 may access the prescription data 234, and notify, the patient 210, via a notification on the mobile communication device 204, when he or she is scheduled to take a dose of the prescription.

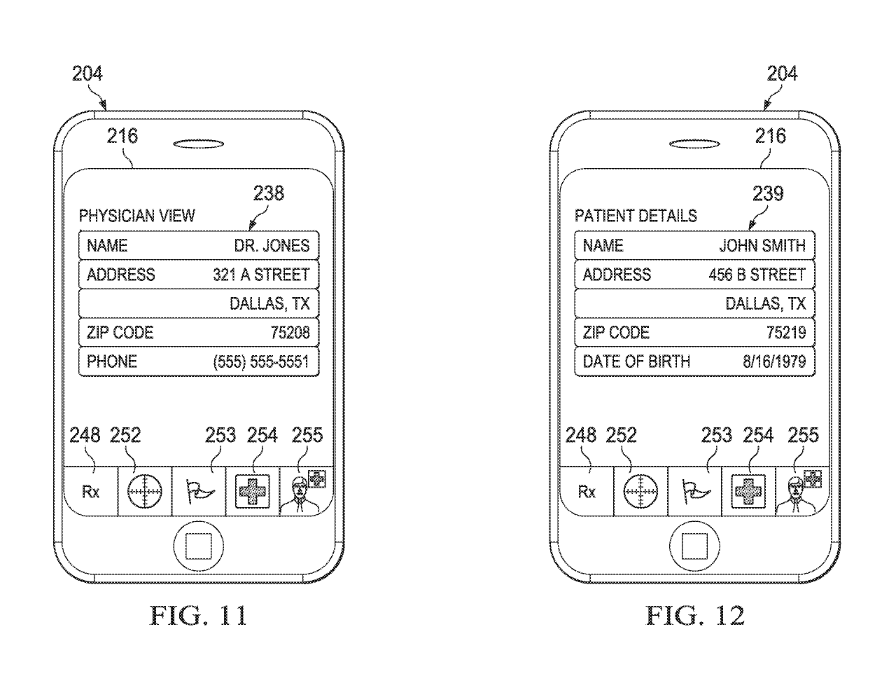

The patient 210 may also select a physician data module activation button 255 to cause the physician data module 232 to retrieve and display the physician data 238, as shown in FIG. 11. As an example, when the physician data module 232 is selected, the physician data module 232 may display the name of the physician, the address of the physician, the ZIP code of the physician, the phone number of the physician, the e-mail address of the physician, or any other data related to the physician or other health care worker associated with the prescription or patient 210.

The patient 210 may also select a patient data module activation button (not shown) to cause the patient data module 233 to retrieve and display the patient data 239, as shown in FIG. 12. As an example, when the patient data module 233 is selected, the patient data module 233 may display the name of the patient 210, the address of the patient 210, the ZIP code of the patient 210, the phone number of the patient 210, the e-mail address of the patient 210, the date of birth of the patient 210, or any other data related to the patient 210 or any other patient associated with the prescription management application 202.

In one embodiment, the prescription management application 202 may also have application settings that are customizable or changeable by the patient 210. For example, the patient 210 may change the method by which the patient 210 is notified when his or her prescription is ready for retrieval at the pharmacy 212. Non-limiting examples of the type of notification the patient 210 may receive include a graphical notification, such as the prescription availability notification 214, or an audio notification. The patient 210 may also select the events for which he or she desires to be notified. For example, the patient 210 may select to be notified when the prescription is ready for retrieval from the pharmacy 212, when a prescription refill has been scheduled by the pharmacy 212, when the prescription expiration date is imminent, when the pharmacy 212 issues a projected refill date or time at which the prescription will be filled, etc. The patient 210 may also select his or her preferred pharmacy or physician. The patient 210 may also select an amount of time before a particular event that he or she desires to be notified, such as a predetermined amount of time before the pharmacy 212 closes or a predetermined amount of time before the pharmacy 212 refills the patient's prescription.

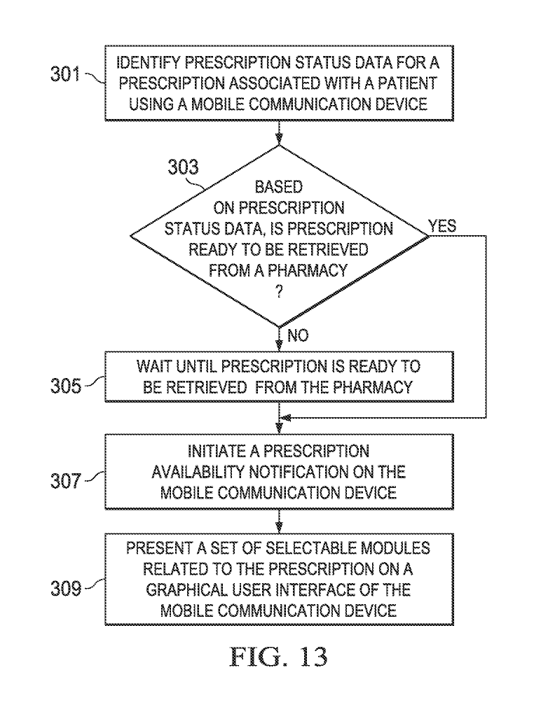

Referring to FIG. 13, an illustrative embodiment of a process for managing prescription-related health care data, which may be executed by a prescription management application, such as the prescription management application 102 in FIG. 1 or the prescription management application 202 in FIG. 2, includes identifying prescription status data for a prescription associated with a patient using a mobile communication device (step 301). The process determines whether the prescription is ready to be retrieved from a pharmacy based on the prescription status data (step 303). If the process determines that the prescription is not ready to be retrieved from the pharmacy, the process waits until the prescription is ready to be retrieved from the pharmacy (step 305). The process then proceeds to step 307.

Returning to step 303, if the process determines that the prescription is ready to be retrieved from the pharmacy, the process initiates a prescription availability notification on the mobile communication device (step 307). The process then presents a set of selectable modules related to the prescription on a graphical user interface of the mobile communication device (step 309).

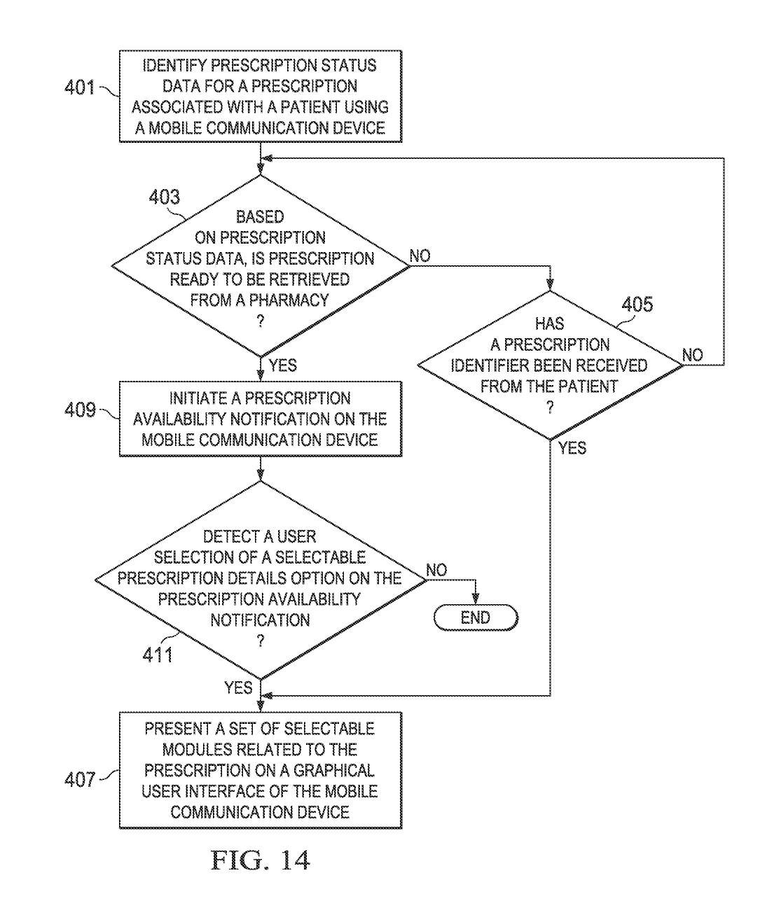

Referring to FIG. 14, an illustrative embodiment of a process for managing prescription-related health care data, which may be executed by the prescription management application 102 in FIG. 1 or the prescription management application 202 in FIG. 2, includes identifying prescription status data for a prescription associated with a patient using a mobile communication device (step 401). The process determines whether the prescription is ready to be retrieved from a pharmacy based on prescription status data (step 403). If the process determines that the prescription is not ready to be retrieved from the pharmacy, the process determines whether a prescription identifier has been received from the patient (step 405). In one embodiment, the prescription identifier may be received via the prescription identifier field 250 in FIG. 4. If the process determines that the prescription identifier has not been received from the patient, the process returns to step 403.

Returning to step 405, if the process determines that the prescription identifier has been received from the patient, the process presents a set of selectable modules related to the prescription on a graphical user interface of the mobile communication device (step 407).

Returning to step 403, if the process determines that the prescription is ready to be retrieved from the pharmacy, the process initiates a prescription availability notification on the mobile communication device (step 409). The process determines whether a user selection of a selectable prescription details option on the prescription availability notification has been detected (step 411). If the process determines that a user selection of the selectable prescription details option has been detected, the process proceeds to step 407, in which the process presents a set of selectable modules related to the prescription on the graphical user interface of the mobile communication device. If the process determines that a user selection of the selectable prescription details option on the prescription availability notification has not been detected, the process terminates.

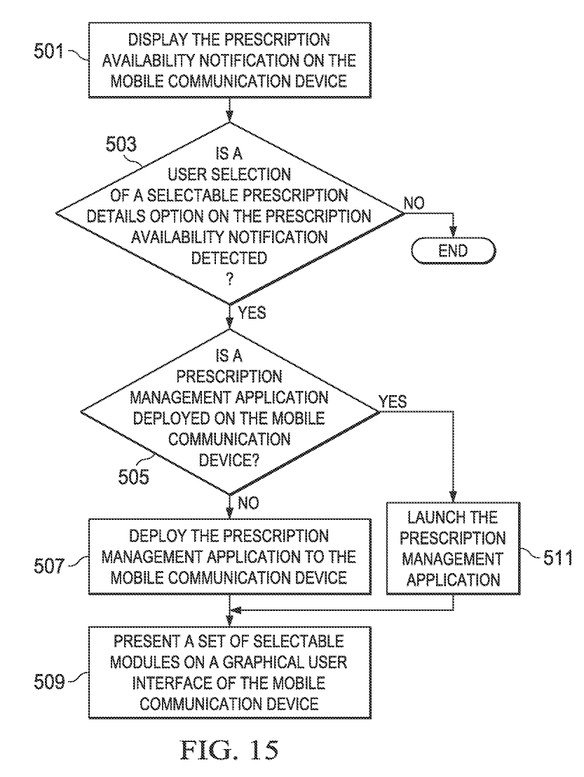

Referring to FIG. 15, an illustrative embodiment of a process for initiating a prescription availability notification on the mobile communication device and presenting a set of selectable modules related to the prescription on a graphical user interface, referred to in steps 307 and 309 in FIG. 13, may include displaying the prescription availability notification on the mobile communication device (step 501). The process determines if a user selection of the selectable prescription details option on a prescription availability notification is detected (step 503). If the process determines that a user selection of the selectable prescription details option on the prescription availability notification is not detected, the process terminates.

Returning to step 503, if the process determines that a user selection of the selectable prescription details option on the prescription availability notification is detected, the process determines whether a prescription management application is deployed on the mobile communication device (step 505). If the process determines that the prescription management application is not deployed on the mobile communication device, the process deploys the prescription management application to the mobile communication device (step 507). The process then presents a set of selectable modules on a graphical user interface of the mobile communication device (step 509).

Returning to step 505, if the process determines that prescription management application is deployed on the mobile communication device, the process launches the prescription management application (step 511). The process then presents the set of selectable modules on the graphical user interface of the mobile communication device (step 509). According to one illustrative embodiment, step 509 may be considered to be part of launching the prescription management application, as described in step 511.

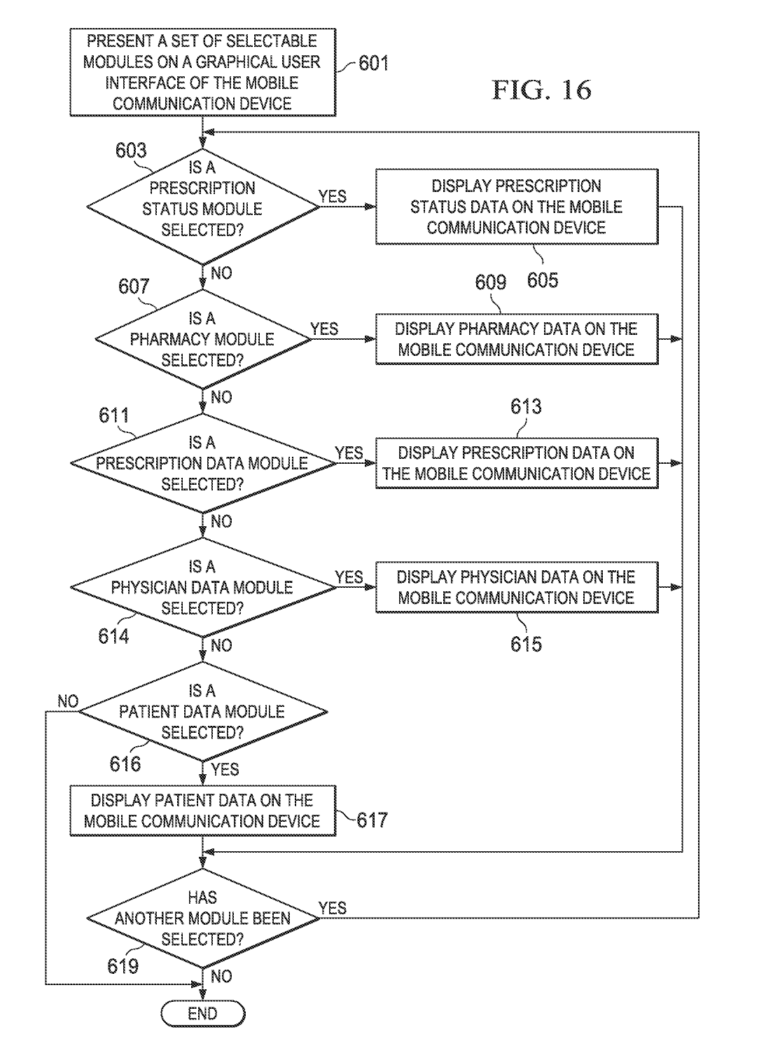

Referring to FIG. 16, an illustrative embodiment of a process for managing prescription-related health care data that may be executed by the prescription management application 102 in FIG. 1 or the prescription management application 202 in FIG. 2 includes presenting a set of selectable modules on a graphical user interface of the mobile communication device (step 601). The process determines whether a prescription status module is selected (step 603).

If the process determines that the prescription status module is selected, the process displays prescription status data on the mobile communication device (step 605). The process then proceeds to step 619.

Returning to step 603, if the process determines that the prescription status module is not selected, the process determines whether a pharmacy module is selected (step 607). If the process determines that the pharmacy module is selected, the process displays pharmacy data on the mobile communication device (step 609). The process then proceeds to step 619.

Returning to step 607, if the process determines that the pharmacy module is not selected, the process determines whether a prescription data module is selected (step 611). If the process determines that the prescription data module is selected, the process displays prescription data on the mobile communication device (step 613). The process then proceeds to step 619.

Returning to step 611, if the process determines that the prescription data module is not selected, the process determines whether a physician data module is selected (step 614). If the process determines that the physician data module is selected, the process displays physician data on the mobile communication device (step 615). The process then proceeds to step 619.

Returning to step 614, if the process determines that the physician data module is not selected, the process determines whether the patient data module is selected (step 616). If the process determines that the patient data module is selected, the process displays patient data on the mobile communication device (step 617). Returning to step 616, if the process determines that the patient data module is not selected, the process then terminates.

Proceeding to step 619, the process determines whether another selectable module has been selected. If the process determines that another selectable module has been selected, the process may return to step 603. Returning to step 619, if the process determines that another module has not been selected, the process then terminates.

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the Figures. For example, in some cases, two blocks shown in succession may be executed substantially concurrently, or the blocks may sometimes be executed in the reverse order, depending upon the functionality involved.

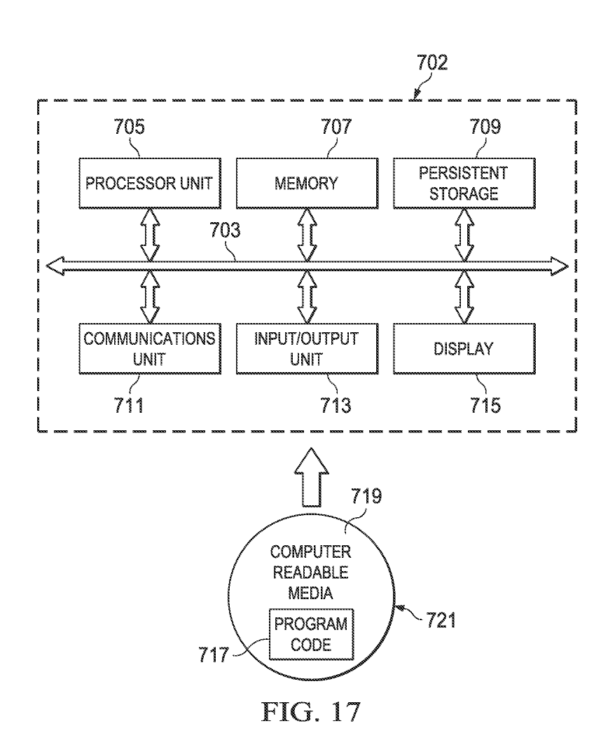

Referring to FIG. 17, a block diagram of a computing device 702 is shown in which illustrative embodiments may be implemented. The computing device 702 may be the mobile communication device 104 or 204 described in FIG. 1 or 2, respectively. In another embodiment, the health care management hub 106 or 206 in FIG. 1 or 2, respectively, may be implemented on the computing device 702. Computer-usable program code or instructions implementing the processes used in the illustrative embodiments may be located on the computing device 702. The computing device 702 includes a communications fabric 703, which provides communications between a processor unit 705, a memory 707,, a persistent storage 709, a communications unit 711, an input/output (I/O) unit 713, and a display 715.

The processor unit 705 serves to execute instructions for software that may be loaded into the memory 707. The processor unit 705 may be a set of one or more processors or may be a multi-processor core, depending on the particular implementation. Further, the processor unit 705 may be implemented using one or more heterogeneous processor systems in which a main processor is present with secondary processors on a single chip. As another illustrative example, the processor unit 705 may be a symmetric multi-processor system containing multiple processors of the same type.

The memory 707, in these examples, may be, for example, a random access memory or any other suitable volatile or non-volatile storage device. The persistent storage 709 may take various forms depending on the particular implementation. For example, the persistent storage 709 may contain one or more components or devices. For example, the persistent storage 709 may be a hard drive, a flash memory, a rewritable optical disk, a rewritable magnetic tape, or some combination of the above. The media used by the persistent storage 709 also may be removable. For example, a removable hard drive may be used for the persistent storage 709.

The communications unit 711, in these examples, provides for communications with other data processing systems or communication devices. In these examples, the communications unit 711 may be a network interface card. The communications unit 711 may provide communications through the use of either or both physical and wireless communication links.

The input/output unit 713 allows for the input and output of data with other devices that may be connected to the computing device 702. For example, the input/output unit 713 may provide a connection for user input through a keyboard and mouse. Further, the input/output unit 713 may send output to a processing device. In the case in which the computing device 702 is a cellular phone, the input/output unit 713 may also allow devices to be connected to the cellular phone, such as microphones, headsets, and controllers. The display 715 provides a mechanism to display information to a user, such as a graphical user interface. The display 715 may be used to display. prompts or modules described in the illustrative embodiments.

Instructions for the operating system and applications or programs are located on the persistent storage 709. These instructions may be loaded into the memory 707 for execution by the processor unit 705. The processes of the different embodiments may be performed by the processor unit 705 using computer-implemented instructions, which may be located in a memory, such as the memory 707. These instructions are referred to as program code, computer-usable program code, or computer-readable program code that may be read and executed by a processor in the processor unit 705. The program code in the different embodiments may be embodied on different physical or tangible computer-readable media, such as the memory 707 or the persistent storage 709.

Program code 717 is located in a functional form on a computer-readable media 719 and may be loaded onto or transferred to the computing device 702 for execution by the processor unit 705. The program code 717 and the computer-readable media 719 form computer program product 721 in these examples. In one embodiment, the computer program product 721 is the prescription management application 102 or 202 in FIG. 1 or 2, respectively. In this embodiment, the computing device 702 may be the mobile communication device 104 or 204 in FIG. 1 or 2, respectively, and the program code 717 may include computer-usable program code capable of identifying prescription status data for a prescription associated with a patient. The patient may be a user of a mobile communication device. The program code 717 may also include computer-usable program code capable of determining whether the prescription is ready for retrieval from a pharmacy using the prescription status data, and initiating a prescription availability notification on the mobile communication device in response to determining that the prescription is ready for retrieval from the pharmacy. The prescription availability notification notifies the patient that the prescription is ready for retrieval from the pharmacy. The program code 717 may also include computer-usable program code capable of presenting a set of selectable modules on a graphical user interface of the mobile communication device. At least a portion of the set of selectable modules may be related to the prescription.

In another embodiment, the program code 717 may include computer-usable program code capable of initiating a prescription availability notification on the mobile communication device in response to determining that a prescription associated with the patient is ready for retrieval from a pharmacy, and presenting, for patient selection, a set of selectable modules on the graphical user interface of the mobile communication device. The set of selectable modules may include at least one of a prescription status module, a pharmacy module, a prescription data module, or a physician module. Any combination of the above-mentioned computer-usable program code may be implemented in the program code 717, and any functions of the illustrative embodiments may be implemented in the program code 717.

In one example, the computer-readable media 719 may be in a tangible form, such as, for example, an optical or magnetic disc that is inserted or placed into a drive or other device that is part of the persistent storage 709 for transfer onto a storage device, such as a hard drive that is part of the persistent storage 709. In a tangible form, the computer-readable media 719 also may take the form of a persistent storage, such as a hard drive or a flash memory that is connected to the computing device 702. The tangible form of the computer-readable media 719 is also referred to as computer recordable storage media.

Alternatively, the program code 717 may be transferred to the computing device 702 from the computer-readable media 719 through a communication link to the communications unit 711 or through a connection to the input/output unit 713. The communication link or the connection may be physical or wireless in the illustrative examples. The computer-readable media 719 also may take the form of non-tangible media, such as communication links or wireless transmissions containing the program code 717.

The different components illustrated for the computing device 702 are not meant to provide architectural limitations to the manner in which different embodiments may be implemented. The different illustrative embodiments may be implemented in a data processing system including components in addition to or in place of those illustrated for computing device 702. Other components shown in FIG. 17 can be varied from the illustrative examples shown.

As one example, a storage device in the computing device 702 is any hardware apparatus that may store data. The memory 707, the persistent storage 709, and the computer-readable media 719 are examples of storage devices in a tangible form.

In another example, a bus system may be used to implement the communications fabric 703 and may be comprised of one or more buses, such as a system bus or an input/output bus. Of course, the bus system may be implemented using any suitable type of architecture that provides for a transfer of data between different components or devices attached to the bus system. Additionally, the communications unit 711 may include one or more devices used to transmit and receive data, such as a modem or a network adapter. Further, a memory may be, for example, the memory 707 or a cache such as found in an interface and memory controller hub that may be present in the communications fabric 703.

The principles of the present invention can take the form of an entirely hardware embodiment, an entirely software embodiment, or an embodiment containing both hardware and software elements. In one embodiment, the invention is implemented in software, which includes but is not limited to, firmware, resident software, microcode, and other computer readable code.

Furthermore, the principles of the present invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments Of the invention disclosed with greater particularity.

What is claimed is:

1. A method for managing prescription-related health care data for a patient using a mobile communication device, the method comprising:
identifying prescription status data for a prescription associated with a patient, the patient being a user of a mobile communication device;
determining whether the prescription is ready for retrieval from a pharmacy using the prescription status data;
initiating a prescription availability notification on the mobile communication device in response to determining that the prescription is ready for retrieval from the pharmacy, the prescription availability notification notifying the patient that the prescription is ready for retrieval from the pharmacy; and
presenting a set of selectable modules on a graphical user interface of the mobile communication device, at least a portion of the set of selectable modules related to the prescription.

2. The method of claim 1, wherein initiating the prescription availability notification on the mobile communication device comprises displaying the prescription availability notification on the graphical user interface of the mobile communication device, the prescription availability notification comprising a selectable prescription details option, the method further comprising:
detecting a user selection of the selectable prescription details option; and
presenting the set of selectable modules on a graphical user interface of the mobile communication device in response to detecting the user selection of the selectable prescription details option.

3. The method of claim 1, further comprising:
receiving the prescription status data from the pharmacy; and
storing the prescription status data in a health care database.

4. The method of claim 3, wherein receiving the prescription status data from the pharmacy comprises receiving, from the pharmacy, a retrievability status that the prescription is ready for retrieval from the pharmacy.

5. The method of claim 1, wherein presenting the set of selectable modules comprises presenting, for user selection, a prescription status module, a pharmacy module, a prescription data module, and a physician module, the method further comprising:
executing one of the set of selectable module at a time based on the user selection.

6. The method of claim 1, wherein identifying the prescription status data for the prescription comprises:
accessing a health care database; and
identifying the prescription status data for the prescription in the health care database.

7. The method of claim 6, wherein determining whether the prescription is ready for retrieval from the pharmacy comprises accessing a retrievability status in the health care database.

8. The method of claim 1, wherein the set of selectable modules comprises a pharmacy module, the pharmacy module, when selected by the patient, displaying a location of the pharmacy on the graphical user interface of the mobile communication device.

9. The method of claim 1, wherein the set of selectable modules comprises a prescription status module, the prescription status module, when selected by the patient, displaying the prescription status data for the prescription on the graphical user interface of the mobile communication device.

10. The method of claim 1, wherein the set of selectable modules comprises a prescription data module, the prescription data module, when selected by the patient, displaying prescription data for the prescription on the graphical user interface of the mobile communication device.

11. The method of claim 1, wherein the set of selectable modules comprises a physician data module, the physician data module, when selected by the patient, displaying physician data on the graphical user interface of the mobile communication device.

12. A prescription management system for managing prescription-related health care data for a patient using a mobile communication device, the prescription management system comprising:
a health care database comprising prescription data associated with a set of prescriptions for a set of patients, the prescription data comprising prescription status data associated with the set of prescriptions; and
a prescription management application executable on a mobile communication device associated with a patient, the prescription management application comprising a prescription status module to retrieve the prescription status data for a prescription associated with the patient from the health care database and to present the prescription status data on a graphical user interface of the mobile communication device.

13. The prescription management system of claim 12, wherein the prescription management application further comprises a prescription data module to retrieve the prescription data for the prescription from the health care database and to present the prescription data on the graphical user interface.

14. The prescription management system of claim 12, wherein the health care database further comprises pharmacy data for a set of pharmacies, and wherein the prescription management application further comprises a pharmacy module to retrieve the pharmacy data for a pharmacy associated with the prescription and to present the pharmacy data for the pharmacy on the graphical user interface.

15. The prescription management system of claim 14, wherein the pharmacy data comprises pharmacy location data, and wherein the pharmacy module comprises a pharmacy locator to retrieve the pharmacy location data and to present the pharmacy location data on the graphical user interface.

16. The prescription management system of claim 15, wherein the pharmacy locator comprises a pharmacy mapper to present the pharmacy location data on the graphical user interface using a map.

17. The prescription management system of claim 12, wherein the health care database further comprises physician data, and wherein prescription management application further comprises a physician data module to retrieve the physician data and to present the physician data on the graphical user interface.

18. The prescription management system of claim 12, wherein the prescription status data comprises a retrievability status for the prescription, and wherein the prescription status module initiates a prescription availability notification for the prescription when the prescription has a retrievable status.

19. The prescription management system of claim 12, wherein prescription management application displays a prescription entry prompt on the graphical user interface of the mobile communication device in response to a user selection, the prescription entry prompt comprising a prescription identifier field;
wherein the prescription management application receives, from the patient, a prescription identifier in the prescription identifier field; and
wherein the prescription management application identifies the prescription using the prescription identifier inputted by the patient.

20. A computer program product comprising:
a computer-usable medium having computer-usable program code for managing prescription-related health care data for a patient using a mobile communication device, the computer program product comprising:
computer-usable program code for initiating a prescription availability notification on the mobile communication device in response to determining that a prescription associated with the patient is ready for retrieval from a pharmacy; and
computer-usable program code for presenting, for patient selection, a set of selectable modules on the graphical user interface of the mobile communication device, the set of selectable modules comprising at least one of a prescription status module, a pharmacy module, a prescription data module, or a physician module.
